(19) United States
(12) Patent Application Publication
(10) Pub. No.: US 2026/0260109 A1
(43) Pub. Date: Sep. 3, 2026

(54) GENERATING HUMAN-READABLE SYNTHETIC TEXT FOR TRAINING GENERATIVE NEURAL NETWORKS

(71) Applicant: Google LLC, Mountain View, CA (US)

(72) Inventors: Vahab Seyed Mirrokni, Short Hills, NJ (US); Meisam Razaviyayn, Glendale, CA (US); MohammadHossein Bateni, South Orange, NJ (US); Zeman Li, Los Angeles, CA (US); Baharan Mirzasoleimanbarzi, Los Angeles, CA (US); Tuan Hai Dang Nguyen, Los Angeles, CA (US)

(21) Appl. No.: 19/467,696

(22) Filed: Feb. 2, 2026

Related U.S. Application Data
(60) Provisional application No. 63/752,607, filed on Jan. 31, 2025.

(51) Int. Cl. G06N 3/08; G06N 3/0475

(52) U.S. Cl. CPC G06N 3/08; G06N 3/0475

(57) ABSTRACT

Methods, systems, and apparatus, including computer programs encoded on a computer storage medium, for generating human-readable synthetic text for training generate neural networks thereon.

### CROSS-REFERENCE TO RELATED APPLICATIONS

This application claims priority to U.S. Provisional Application No. 63/752,607, filed on Jan. 31, 2025. The disclosure of the prior application is considered part of and is incorporated by reference in its entirety in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

This specification also relates to training neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

A general trend with neural networks has been to make larger and more complicated networks in order to achieve higher accuracy. As neural networks increase in size and complexity in service of increased accuracy, they also increase in computational and communication cost during the training of the neural networks.

### SUMMARY

This specification describes a training system implemented as computer programs on one or more computers in one or more locations that can generate human-readable synthetic text to train a generative neural network thereon.

According to a first aspect method performed by one or more computers is provided for fine-tuning a generative neural network that has been pre-trained on a vocabulary of tokens, the method comprising: receiving a source dataset for a downstream task to be performed by the generative neural network, each sample in the source dataset being a sequence of tokens in the vocabulary; generating a target dataset for the downstream task that satisfies a system of constraints comprising: (i) a constraint that each sample in the target dataset is a sequence of tokens in the vocabulary having a readability score that satisfies a threshold, and (ii) a constraint that, upon training the generative neural network on the target dataset, a performance metric of the generative neural network on the downstream task is optimized when the generative neural network is evaluated on the source dataset to determine the performance metric; and training the generative neural network on the target dataset for the downstream task.

In some implementations of the method, the readability score is a perplexity score.

In some implementations of the method, training the generative neural network on the target dataset for the downstream task comprises: evaluating the generative neural network on the target dataset to determine a target performance metric of the generative neural network on the downstream task; and optimizing the target performance metric with respect to a set of network parameters of the generative neural network.

In some implementations of the method, optimizing the target performance metric with respect to the set of network parameters of the generative neural network comprises: computing, with respect to the set of network parameters of the generative neural network, a gradient of the target performance metric; and updating, in accordance with the gradient of the target performance metric, a respective value of each network parameter in the set of network parameters of the generative neural network.

In some implementations of the method, generating the target dataset for the downstream task that satisfies the system of constraints comprises: evaluating the generative neural network on the source dataset for the downstream task to determine a source performance metric of the generative neural network on the downstream task; computing, with respect to the set of network parameters of the generative neural network, a gradient of the source performance metric; evaluating the generative neural network on a primal dataset for the downstream task to determine a primal performance metric of the generative neural network on the downstream task; computing, with respect to the set of network parameters of the generative neural network, a gradient of the primal performance metric; and generating the target dataset by optimizing an objective function, with respect to the primal dataset, while subject to a constraint that each sample in the primal dataset is a sequence of tokens in the vocabulary having a readability score that satisfies a threshold, wherein the objective function measures a similarity between: (i) the gradient of the source performance metric, and (ii) the gradient of the primal performance metric.

In some implementations of the method, the set of network parameters of the generative neural network are the network parameters of a last neural network layer of the generative neural network.

In some implementations of the method, the objective function comprises a cosine similarity between: (i) the gradient of the source performance metric, and (ii) the gradient of the primal performance metric.

In some implementations of the method, evaluating the generative neural network on the source dataset for the downstream task to determine the source performance metric of the generative neural network on the downstream task comprises: encoding each sample in the source data into a respective embedding matrix representing the sample; processing the respective embedding matrix of each sample in the source dataset, using the generative neural network, to determine a respective performance term for the respective sample in the source dataset; and returning, as the source performance metric, a summation comprising the respective performance term for each sample in the source dataset.

In some implementations of the method, evaluating the generative neural network on the primal dataset for the downstream task to determine the primal performance metric of the generative neural network on the downstream task comprises: initializing a primal embedding tensor comprising, for each sample in the primal dataset, a respective embedding matrix representing the sample; processing each embedding matrix in the primal embedding tensor, using the generative neural network, to determine a respective performance term for the respective sample in the primal dataset; and returning, as the primal performance metric, a summation comprising the respective performance term for each sample in the primal dataset.

In some implementations of the method, for each sample in the source and primal datasets, the respective performance term of the sample is a respective cross-entropy loss of the sample.

In some implementations of the method, generating the target dataset by optimizing the objective function, with respect to the primal dataset, while subject to the constraint that each sample in the primal dataset is a sequence of tokens in the vocabulary having a readability score that satisfies a threshold comprises: maintaining a vocabulary embedding comprising, for each token in the vocabulary, a respective embedding vector representing the token; generating a target embedding tensor by optimizing the objective function, with respect to the primal embedding tensor, while subject to a constraint that each embedding matrix in the primal embedding tensor is a sequence of embedding vectors in the vocabulary embedding having a readability score that satisfies a threshold; and decoding each embedding matrix in the target embedding tensor into a respective sample in the target dataset.

In some implementations of the method, generating the target embedding tensor by optimizing the objective function, with respect to the primal embedding tensor, while subject to the constraint that each embedding matrix in the primal embedding tensor is a sequence of embedding vectors in the vocabulary embedding having a readability score that satisfies a threshold comprises: initializing an auxiliary embedding tensor and a dual embedding tensor; generating an output embedding tensor by optimizing an augmented Lagrange function, with respect to the primal, auxiliary, and dual embedding tensors, while subject to a constraint that each embedding matrix in the auxiliary embedding tensor is a sequence of embedding vectors in the vocabulary embedding having a readability score that satisfies a threshold, wherein the augmented Lagrange function comprises the objective function and a penalty function that measures a similarity between: (i) a residual embedding tensor comprising a difference between the primal and auxiliary embedding tensors, and (ii) the dual embedding tensor; and projecting each embedding vector of each embedding matrix in the output embedding tensor to generate a respective embedding vector of a respective embedding matrix in the target embedding tensor, comprising: determining, for the embedding vector of the embedding matrix in the output embedding tensor, a respective top-k subset of the vocabulary embedding; identifying, in the respective top-k subset, a respective embedding vector of a token having a highest similarity with the embedding vector of the embedding matrix in the output embedding tensor; and returning, as the respective embedding vector of the respective embedding matrix in the target embedding tensor, the respective embedding vector of the token having the highest similarity with the embedding vector of the embedding matrix in the output embedding tensor.

In some implementations of the method, the penalty function comprises a squared Euclidian distance between: (i) the residual embedding tensor comprising the difference between the primal and auxiliary embedding tensors, and (ii) the dual embedding tensor.

In some implementations of the method, the squared Euclidian distance is multiplied by a penalty parameter.

In some implementations of the method, determining, for the embedding vector of the embedding matrix in the output embedding tensor, the respective top-k subset of the vocabulary embedding comprises: receiving a currently projected embedding matrix comprising, for each preceding embedding vector of the embedding matrix in the output embedding tensor, the respective embedding vector of the token having the highest similarity with the preceding embedding vector; generating a probability distribution over the vocabulary embedding conditioned on the currently projected embedding matrix; determining, from the probability distribution over the vocabulary embedding, a respective likelihood of each embedding vector in the vocabulary embedding; and returning, as the top-k subset of the vocabulary embedding, the k embedding vectors in the vocabulary embedding having the highest respective likelihoods.

In some implementations of the method, generating the probability distribution over the vocabulary embedding conditioned on the currently projected embedding matrix comprises: processing the currently projected embedding matrix, using the generative neural network, to generate the probability distribution over the vocabulary embedding.

In some implementations of the method, generating the output embedding tensor by optimizing the augmented Lagrange function, with respect to the primal, auxiliary, and dual embedding tensors, while subject to the constraint that each embedding matrix in the auxiliary embedding tensor is a sequence of embedding vectors in the vocabulary embedding having a readability score that satisfies a threshold comprises: for each of a plurality of iterations: receiving a primal, auxiliary, and dual embedding tensor for the current iteration; evaluating the augmented Lagrange function on the primal, auxiliary, and dual embedding tensors for the current iteration; optimizing the augmented Lagrange function evaluated on the primal, auxiliary, and dual embedding tensors for the current iteration, with respect to the primal embedding tensor for the current iteration, to generate the primal embedding tensor for the next iteration; generating an input embedding tensor for the current iteration comprising a summation of the primal embedding tensor for the next iteration and the dual embedding tensor for the current iteration; projecting each embedding vector of each embedding matrix in the input embedding tensor for the current iteration to generate a respective embedding vector of a respective embedding matrix in the auxiliary embedding tensor for the next iteration, comprising: determining, for the embedding vector of the embedding matrix in the input tensor for the current iteration, a respective top-k subset of the vocabulary embedding; identifying, in the respective top-k subset, a respective embedding vector of a token having a highest similarity with the embedding vector of the embedding matrix in the input embedding tensor for the current iteration; and returning, as the respective embedding vector of the respective embedding matrix in the auxiliary embedding tensor for the next iteration, the respective embedding vector of the token having the highest similarity with the embedding vector of the embedding matrix in the input embedding tensor for the current iteration; and incrementing the dual embedding tensor for the current iteration, with the residual embedding tensor for the next iteration, to generate the auxiliary embedding tensor for the next iteration; and returning, as the output embedding tensor, the primal embedding tensor for the final iteration.

In some implementations of the method, the method further comprising evaluating the generative neural network on the source dataset to determine the performance metric that is optimized upon training the generative neural network on the target dataset.

In some implementations of the method, each sample in the source and target datasets is a sequence of tokens in the vocabulary comprising: (i) a respective input sequence of tokens in the vocabulary describing a respective implementation of the downstream task; and (ii) a corresponding output sequence of tokens in the vocabulary describing an expected result of the respective implementation of the downstream task.

In some implementations of the method, the method further comprising, upon training the generative neural network on the target dataset for the downstream task: receiving an input sequence of tokens in the vocabulary describing an implementation of the downstream task; and processing the input sequence, using the generative neural network, to generate an output sequence of tokens in the vocabulary describing a result of the implementation of the downstream task.

In some implementations of the method, the source dataset comprises real samples created by humans.

In some implementations of the method, the source dataset consists of the real samples created by humans.

In some implementations of the method, the generative neural network is a neural language model.

In some implementations of the method, the neural language model is a multi-modal neural language model.

In some implementations of the method, the generative neural network is a first generative neural network, and the method further comprises training a second generative neural network on the target dataset for the downstream task.

In a second aspect, one or more non-transitory computer storage media are provided. The one or more non-transitory computer storage media storing instructions that, when executed by one or more computers, cause the one or more computers to perform operations of the respective method of the first aspect in any of its abovementioned implementations.

In a third aspect, a system is provided. The system includes one or more computers; and one or more storage devices communicatively coupled to the one or more computers, wherein the one or more storage devices store instructions that, when executed by the one or more computers, cause the one or more computers to perform operations of the respective method of the first aspect in any of its abovementioned implementations.

The subject matter described in this specification can be implemented in particular embodiments so as to realize one or more of the following advantages.

This specification describes a training system that can generate a synthetic dataset for a downstream task to be performed by a generative neural network, based on a real dataset for the downstream task, while satisfying a system of constraints imposed on the synthetic dataset, e.g., readability and performance constraints on samples in the synthetic dataset. The training system can then train the generative neural network on the synthetic dataset to perform the downstream task to equivalent performance as if the generative neural network were trained on the real dataset.

Synthetic data has the potential to improve the performance, training efficiency, and privacy of real training examples. Nevertheless, existing approaches for synthetic text generation are mostly heuristics and cannot generate human-readable text without compromising the privacy of real data, or provide performance guarantees for training generative neural networks. This specification provides an approach for generating synthetic human-readable text that guarantees the convergence and performance of the generative neural network during fine-tuning on a target, downstream task. The training system described herein is particularly effective when the original dataset: (i) cannot be used for training because it contains private data or for other reasons; (ii) is too small and more training data is needed to effectively train the generative neural network; or (iii) is too large and needs to be condensed in order to train the generative neural network in a more computationally efficient manner.

To accomplish this, the training system leverages Alternating Direction Method of Multipliers (“ADMM”) that iteratively optimizes the embeddings of synthetic examples to match the gradient of the target training or validation data, and maps them to a sequence of text tokens with low perplexity. In doing so, the generated synthetic text can guarantee convergence of the model to a close neighborhood of the solution obtained by fine-tuning on real data. At the same time, the generated text is guaranteed to be different from real data. Experiments on various classification and generation tasks confirm the effectiveness of the training system.

Thus, the described techniques allow for a generative neural network to be effectively trained on synthetic text in order to (i) preserve the privacy and security of the original text, (ii) compress the original data set so that the generative neural network can achieve high quality performance in a more computationally efficient manner or (iii) expand on the original data set to generate sufficient data for training the generative neural network to have high quality performance without needing additional real data.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example training system.

FIG. 2 is a flow diagram of an example process for fine-tuning the generative neural network on the target dataset.

FIG. 3 is a flow diagram of an example process for generating a target embedding tensor.

FIG. 4 shows an example of the performance of the described techniques.

FIG. 5 shows another example of the performance of the described techniques.

Like reference numbers and designations in the various drawings indicate like elements.

### DETAILED DESCRIPTION

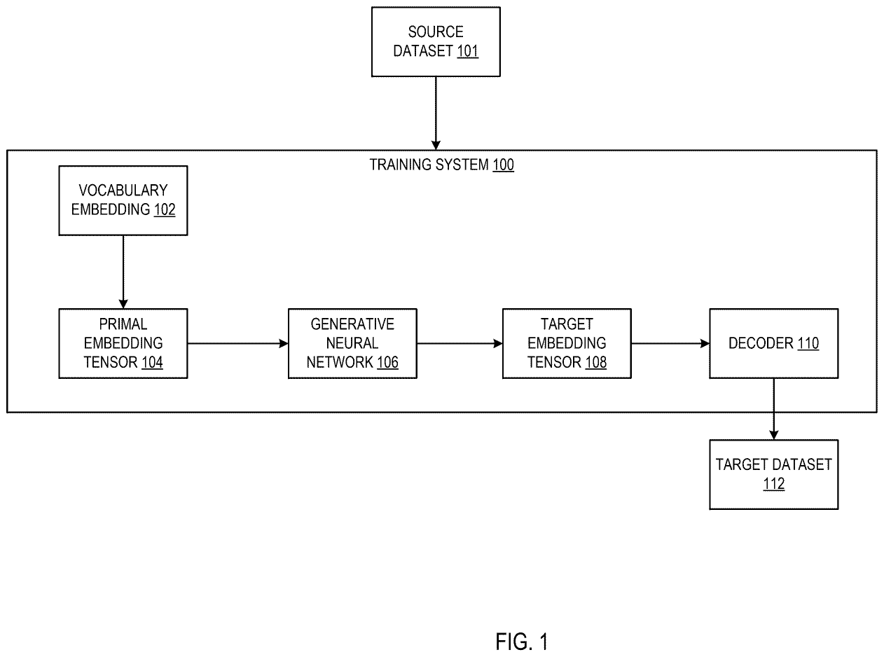

FIG. 1 shows an example training system 100.

The training system 100 is an example of a system implemented as computer programs on one or more computers in one or more locations in which the systems, components, and techniques described below are implemented.

The system 100 generates a synthetic target dataset 112 for fine-tuning a generative neural network 106 and then fine-tunes, i.e., further trains, the generative neural network 106 using the synthetic target dataset.

More specifically, the system 100 receives a source dataset 101 that contains real samples for a downstream task and processes the source dataset 101 to generate to generate the synthetic target dataset 112 that includes synthetic samples for the downstream task.

Generally, each sample in the source and target datasets is a sequence of tokens in the vocabulary including (i) a respective input sequence of tokens in the vocabulary describing a respective implementation of the downstream task and (ii) a corresponding output sequence of tokens in the vocabulary describing an expected result of the respective implementation of the downstream task.

A token is a discrete fundamental unit, such as a word, subword, or character, that belongs to the vocabulary a generative neural network is trained to recognize and use.

That is, the vocabulary of the generative neural network is a discrete set of tokens that the generative neural network is configured to receive as input. For example, the generative neural network can be configured to map each token in the vocabulary to a respective embedding as part of processing a given input sequence or generating an output sequence.

The downstream can generally be any of a variety of downstream tasks. Some examples of downstream tasks are described below.

A “real” sample is one that is received as input by the system 100. For example, depending on the task, a real sample can be generated from user labels of inputs, from user interactions with a software system, or extracted from logs of a software system.

A “synthetic” sample is one that is generated by the system 100. That is, the “synthetic” samples are the same type of data as the “real” samples but are generated by the system 100.

To generate a human-readable synthetic target dataset for fine-tuning a generative neural network 106 with similar dynamics to that of the real data in the source data set 101, the training system 100 performs an iterative process that includes repeatedly evaluating the generative neural network 106 on both the source dataset 101, which contains real samples for the downstream task, and a primal dataset, which contains a set of synthetic samples.

Evaluating the generative neural network on samples from both the source and primal datasets allows the training system 100 to determine respective performance metrics and compute the gradient of these metrics with respect to the network parameters for gradient matching, subject to a system of constraints imposed on the generated target dataset, e.g., readability and performance constraints on samples in the target dataset.

The training system 100 evaluates the generative neural network 106 on the primal dataset to determine a primal performance metric of the generative neural network on the downstream task.

Each synthetic sample s in the primal dataset is a sequence of n tokens from the vocabulary of the generative neural network 106.

To facilitate gradient matching, instead of representing each synthetic sample s using discrete tokens, each synthetic sample can be represented in a continuous embedding space as an embedding matrix x∈ [symbol] ^{n×d}, where dis the embedding dimension and row xⱼ∈ [symbol] ^{d} is the j^{th} token embedding.

That is, xⱼ∈E, where E={e₁, e₂, . . . , e_{|V|}} denote the vocabulary embedding 102, which is the set of all token embeddings in the vocabulary V of the generative neural network 106, where eᵢ ∈ [symbol] ^{d}. The vocabulary embedding 102 therefore includes, for each token in the vocabulary of the generative neural network 106, a respective embedding vector representing the token. By stacking the embedding matrices of all synthetic samples in the primal dataset, the primal dataset can be represented as a primal embedding tensor 104.

The generative neural network 106 processes each embedding matrix in the primal embedding tensor 104 to determine a respective performance term for the respective sample in the primal dataset. For each sample in the primal dataset, the respective performance term for the sample can be, for example, a respective cross-entropy loss of the sample.

The training system 100 can then return, as the primal performance metric, a summation of the respective performance term for each sample in the primal dataset. The training system 100 can compute, with respect to the set of network parameters of the generative neural network, a gradient of the primal performance metric.

Similarly, the training system 100 evaluates the generative neural network 106 on the source dataset to determine a source performance metric of the generative neural network 106 on the downstream task. Each real sample can include a pair of prompt and response, where the prompt and response can each be a sequence of tokens in the vocabulary of the generative neural network 106.

For each sample in the source dataset, the training system 100 can encode the sample into a respective embedding matrix representing the sample.

The generative neural network 106 then processes the respective embedding matrix of each sample in the source dataset to determine a respective performance term for the respective sample in the source dataset.

The training system 100 can then return, as the source performance metric, a summation of the respective performance terms for each sample in the source dataset. Like the primal dataset, for each sample in the source dataset, the respective performance term for the sample can be, for example, a respective cross-entropy loss of the sample. The training system 100 can compute, with respect to the set of network parameters of the generative neural network, a gradient of the source performance metric. In some implementations, the set of network parameters of the generative neural network are the network parameters of a last neural network layer of the generative neural network.

For example, the training system 100 can perform these operations as part of generating a target embedding tensor 108 through ADMM, an iterative optimization process. That is, the target embedding tensor 108 is generated by optimizing an objective function with respect to the primal dataset represented by the primal embedding tensor 104, subject to constraints that each embedding matrix in the primal embedding tensor is a sequence of embedding vectors in the vocabulary embedding having a readability score that satisfies a threshold.

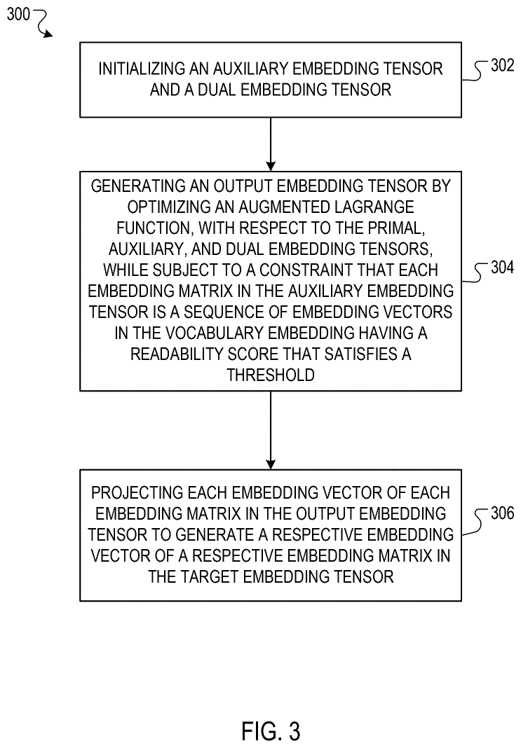

In some implementations, the readability score is a perplexity score. A perplexity score for a sequence of tokens in the vocabulary measures perplexity of the sequence. The generating of a target embedding tensor 108 will be described in further detail below in FIG. 3.

The objective function can measure a similarity between: (i) the gradient of the source performance metric, and (ii) the gradient of the primal performance metric.

In some implementations, the objective function includes a cosine similarity between: (i) the gradient of the source performance metric, and (ii) the gradient of the primal performance metric.

A decoder 110 can then process the target embedding tensor 108 to generate the target dataset 112. The decoder 110 is configured to decode each embedding matrix in the target embedding tensor 108 into a respective sample in the target dataset 112.

Once the target dataset 112 has been generated, the training system 100 can train the generative neural network 106 or a second, different generative neural network on the target dataset 112 for the downstream task. That is, the system 100 can fine-tune an already-trained generative neural network using the target dataset 112. The target dataset 112 does not need to and, in some implementations, does not include any of the real samples from the source dataset 101.

In some implementations, training the generative neural network on the target dataset for the downstream task includes evaluating the generative neural network on the target dataset to determine a target performance metric of the generative neural network on the downstream task and optimizing the target performance metric with respect to a set of network parameters of the generative neural network.

In some implementations, optimizing the target performance metric with respect to the set of network parameters of the generative neural network includes computing, with respect to the set of network parameters of the generative neural network, a gradient of the target performance metric and updating, in accordance with the gradient of the target performance metric, a respective value of some or all of the network parameters in the set of network parameters of the generative neural network.

That is, the system 100 can fine-tune the generative neural network using an objective that is appropriate for the downstream task, e.g., cross-entropy, negative log likelihood, reinforcement learning, and so on.

In some implementations, upon training the generative neural network on the target dataset for the downstream task, the training system receives an input sequence of tokens in the vocabulary describing an implementation of the downstream task and processes the input sequence, using the generative neural network, to generate an output sequence of tokens in the vocabulary describing a result of the implementation of the downstream task.

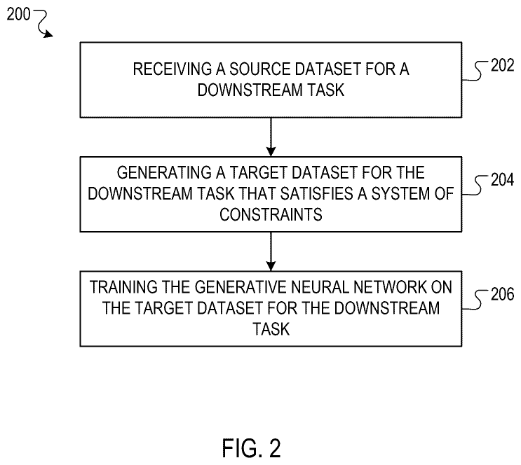

FIG. 2 is a flow diagram of an example process 200 for fine-tuning the generative neural network on the target dataset. For convenience, the process 200 will be described as being performed by a system of one or more computers located in one or more locations. For example, a training system, e.g., the training system 100 of FIG. 1, appropriately programmed in accordance with this specification, can perform the process 200.

The training system first receives a source dataset for a downstream task to be performed by the generative neural network (step 202). This source dataset contains samples of real data for the downstream task. Each sample in the source dataset is a sequence of tokens in the vocabulary of the generative neural network. In some implementations, the source dataset includes, among other data, real samples created by humans or generated from interactions by humans with computer system(s). In some implementations, the source dataset includes only real samples created by humans or generated from interactions by humans with computer system(s).

In some implementations, the source dataset can be a dataset that the system cannot use to train the generative neural network. For example, the source dataset can contain data that needs to be kept secure, e.g., because it is private, and therefore cannot be used to train the generative neural network to avoid the risk that the trained model will expose information from the source dataset. As another example, the source dataset can contain too few samples to effectively train the generative neural network.

The training system then generates a target dataset for the downstream task that satisfies a system of constraints (step 204).

One generated, the training system trains the generative neural network to train on the target dataset of the downstream task (step 206).

The target dataset is a synthetic dataset that the training system generates to finetune the generative neural network on to achieve similar dynamics as training the generative neural network on real data. As described above, by making use of the target dataset for the training instead of the source data set, the system can train the generative neural network to have comparable and in many cases improved performance on the downstream task relative to training the generative neural network on the source data set while preserving the privacy and security of the source data set.

The training system can generate a synthetic dataset for a downstream task based on the real dataset for the downstream task and fine-tune the generative neural network on the synthetic dataset for the downstream task. The training system generates the synthetic dataset such that it satisfies a system of constraints including: (i) a constraint that each sample in the synthetic dataset is readable, and (ii) a constraint that, upon training the generative neural network on the synthetic dataset, a performance metric of the generative neural network on the downstream task is optimized when the generative neural network is evaluated on the real dataset to determine the performance metric. This allows near one-to-one transfer of task knowledge from the real dataset to the synthetic dataset, despite the synthetic dataset including entirely different samples than the real dataset. Moreover, due to this transferability, the training system can use the synthetic dataset to train a second, different generative neural network, e.g., having the same architecture of a different neural network architecture as the first generative neural network that the training system used to generate the synthetic dataset. As a particular example, the different generative neural network can be a larger generative neural network that has the same vocabulary as the original generative neural network, allowing for the synthetic data set to be generated using a smaller neural network and then used to train a larger neural network.

In some implementations, the generative neural network is a neural language model, which in some implementations, is a multi-modal neural language model.

In general, the generative neural network is configured to perform a generative task to generate, as output, data that includes, for example, text data, image data, video data, audio data, or multimodal data that includes data in two or more different modalities. A downstream task refers to a machine learning task that depends on an output of a previous machine learning task, i.e., an upstream task, that the generative neural network is configured to perform. For example, the training system can fine-tune the generative neural network on a synthetic dataset to perform a downstream task, where the training system has generated the synthetic dataset based on a real dataset for the downstream task, and the downstream task benefits from an upstream task that the generative neural network has been pre-trained to perform. Some examples of machine learning tasks, including generative, downstream, and upstream tasks, that the generative neural network can be configured to perform are described in the following.

In some implementations, the generative neural network is configured to perform an image processing task, i.e., receive a network input that includes an image and to process the image to generate a network output for the input image. For example, the image processing task may be image classification and the output generated by the neural network for a given image may be scores for each of a set of object categories, with each score representing an estimated likelihood that the image contains an image of an object belonging to the category. As another example, the image processing task can be image embedding generation and the output generated by the neural network can be a numeric embedding of the input image. As yet another example, the image processing task can be object detection and the output generated by the neural network can identify locations in the input image at which particular types of objects are depicted. As yet another example, the image processing task can be image segmentation and the output generated by the neural network can assign each pixel of the input image to a category from a set of categories.

In some other implementations, the generative neural network is configured to perform an image generation task, where the input is a conditioning input, and the output is a sequence of intensity value inputs for the pixels of an image conditioned on the input.

In some implementations, the generative neural network is configured to perform a neural machine translation task. For example, if the network input to the generate neural network is a sequence of text, e.g., a sequence of words, phrases, characters, or word pieces, in one language, the network output generated by the generative neural network may be a translation of the sequence of text into another language, i.e., a sequence of text in the other language that is a translation of the input sequence of text. The vocabulary for the input tokens may be words, wordpieces or characters of the first language, and the vocabulary for the output tokens may be words, wordpieces or characters of the other language. As a particular example, the neural machine translation task may be a multi-lingual machine translation task, where the generative neural network is configured to translate between multiple different source language-target language pairs. In this example, the source language text may be augmented with an identifier that indicates the target language into which the generative neural network should translate the source language text.

Some implementations may be used for automatic code generation. For example, the input tokens may represent words, wordpieces or characters in a first natural language and the output tokens may represent instructions in a computer programming or markup language, or instructions for controlling an application program to perform a task, e.g., build a data item such as an image or web page.

In some implementations, the generative neural network is configured to perform an audio processing task. For example, if the network input to the generative neural network is a sequence representing a spoken utterance, the network output generated by the generative neural network may be a score for each of a set of pieces of text, each score representing an estimated likelihood that the piece of text is the correct transcript for the utterance. As another example, if the network input is a sequence representing a spoken utterance, the network output can indicate whether a particular word or phrase (“hotword”) was spoken in the utterance. As another example, if the network input is a sequence representing a spoken utterance, the network output can be a classification of the spoken utterance into one of a plurality of categories, for example an identity of the natural language in which the utterance was spoken.

In some implementations, the generative neural network is configured to perform a natural language processing or understanding task, e.g., an entailment task, a paraphrase task, a textual similarity task, a sentiment task, a sentence completion task, a grammaticality task, and so on, that operates on a sequence of text in some natural language.

In some implementations, the generative neural network is configured to perform a text to speech task, where the network input is text in a natural language or features of text in a natural language and the network output is a spectrogram, a waveform, or other data defining audio of the text being spoken in the natural language.

In some implementations, the generative neural network is configured to perform a health prediction task, where the network input is a sequence derived from electronic health record data for a patient and the network output is a prediction that is relevant to the future health of the patient, e.g., a predicted treatment that should be prescribed to the patient, the likelihood that an adverse health event will occur to the patient, or a predicted diagnosis for the patient. Such electronic health data may, for example, comprise one or more sequences of physiological data taken from a patient, with the output being a corresponding prediction that relates to those sequences of data. Examples of physiological data and a corresponding prediction include: blood glucose measurements, with the prediction being a predicted future blood glucose measurement or the prediction of a hyper- or hypo-glycemic event; a heart rate, with the prediction being the presence or absence of a heart condition, or a future cardiac event; blood pressure measurements, with the prediction being the risk of a future heart condition; or the like.

In some implementations, the generative neural network is configured to perform a text generation task, where the network input is a sequence of text, and the network output is another sequence of text, e.g., a completion of the input sequence of text, a response to a question posed in the input sequence, or a sequence of text that is about a topic specified by the first sequence of text. As another example, the network input to the text generation task can be an input other than text, e.g., an image, and the network output sequence can be text that describes the network input.

In some implementations the input sequence represents data to be compressed, e.g., image data, text data, audio data, or any other type of data; and the output sequence a compressed version of the data. The input and output tokens may each comprise any representation of the data to be compressed/compressed data, e.g., symbols or embeddings generated/decoded by a respective neural network.

In some implementations, the generative neural network is configured to perform an agent control task, where the network input is a sequence of observations or other data characterizing states of an environment and the network output defines an action to be performed by the agent in response to the most recent data in the sequence. The agent can be, e.g., a real-world or simulated robot, a control system for an industrial facility, or a control system that controls a different kind of agent. The observations may comprise sensor data captured by sensors associated with (e.g., part of) the agent, for example visual data, LIDAR data, sonar data, agent configuration data (e.g., joint angles), agent orientation data, or the like.

In some implementations, the environment is a real-world environment, the agent is a mechanical (or electro-mechanical) agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example captured by a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements, e.g., steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation, e.g., steering, and movement e.g., braking and/or acceleration of the vehicle.

In some implementations, the environment is a simulation of the above-described real-world environment, and the agent is implemented as one or more computers interacting with the simulated environment. For example, a system implementing the neural network may be used to select actions in the simulated environment during training or evaluation of the system and, after training, or evaluation, or both, are complete, the action selection policy may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations, the generative neural network is configured to perform a genomics task, where the network input is a sequence representing a fragment of a DNA sequence or other molecule sequence and the network output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task performed by the generative neural network is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

In some cases, the machine learning task performed by the generative neural network is a multi-modal processing task that involves processing multi-modal data. In general, multi-modal data is a combination of two or more different types of data, e.g., two or more of audio data, image data, text data, or graph data. As one example, the multi-modal data may comprise audio-visual data, comprising a combination of pixels of an image or of video and audio data representing values of a digitized audio waveform. As another example, the multi-modal data may comprise a combination of i) text data representing text in a natural language and ii) pixels of an image or of video or audio data representing values of an audio waveform. Optionally, but not necessarily, the different types of data may represent the same or overlapping objects using the different modalities (types), and when processing multi-modal data the data may be mapped into a common embedding space.

As a particular example, the machine learning task can be a multi-modal processing task that involves processing both text and image inputs, so that the generative neural network includes both a computer vision neural network and a text processing neural network. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

More generally, the multi-modal processing task may correspond to any of the machine learning tasks previously described for any of the types of data making up the multi-modal combination. For example, an accuracy of the previously described tasks may be increased when the task is applied to multi-modal data combining the data for which the task has been previously described and another type of data. For example detection or classification of an object or event may be improved when data of multiple different types (modalities) is processed.

In particular, the generative neural network is capable of receiving network inputs and generating network outputs for multiple different machine learning tasks. Generally, two machine learning tasks are different if they have different desired outputs for the inputs received for the tasks. For example, two image classification tasks can be different if the object categories into which each task requires classifying input images are different. As another example, two robot learning tasks can be different if the two tasks require generating outputs defining actions to be performed by a robot to reach two different goals.

In practice, for any of these examples, the machine learning task to be performed by the generative neural network can be defined by (at least a part of) the network input, e.g., that is in the form of a prompt or a request, received by the generative neural network. In other words, the generative neural network will be able to perform any of these machine learning tasks when an appropriate prompt or request is received.

In some situations, the generative neural network can be referred to as an auto-regressive neural network when the generative neural network auto-regressively generates an output sequence of tokens as the network output. More specifically, the auto-regressively generated output is created by generating each particular token in the output sequence conditioned on a current input sequence that includes an input sequence included in the network input and any tokens that precede the particular token in the output sequence, i.e., the tokens that have already been generated for any previous positions in the output sequence that precede the particular position of the particular token.

The generative neural network can have any of a variety of neural network architectures, such as convolutional-based neural network architectures, graph-based neural network architecture, recurrent-based neural network architectures, and Transformer-based neural network architectures, e.g., encoder-only Transformer architectures, encoder-decoder Transformer architectures, decoder-only Transformer architectures, diffusion Transformer architectures, other attention-based architectures, and so on.

Examples of such Transformer-based neural network architectures include those described in Colin Raffel, et al., Exploring the limits of transfer learning with a unified text-to-text transformer. arXiv preprint arXiv:1910.10683, 2019; Daniel Adiwardana, et al., Towards a human-like open-domain chatbot. CoRR, abs/2001.09977, 2020; Aakanksha Chowdhery, et al., PaLM: Scaling Language Modeling with Pathways, arXiv preprint arXiv:2204.02311; Rohan Anil, et al. Palm 2 technical report. arXiv preprint arXiv:2305.10403, 2023; and Gemini Team, et al., Gemini: a family of highly capable multimodal models. arXiv preprint arXiv:2312.11805 (2023).

For example, the generative neural network can be a (generative) language model neural network. Examples of generative language model neural networks include Sparrow (Glaese et al. arXiv:2209.14375), Chinchilla (Hoffmann et al. arXiv:2203.15556), and PaLM 2 (Anil, et al. arXiv:2305:10403).

As another example, the generative neural network can be a multi-modal model neural network, e.g., a vision language model (VLM) neural network. Examples of multi-modal neural networks include Flamingo (Alayrac et al. arXiv:2204.14198), PaLI (Chen et al. arXiv: 2209.06794), and PaLI-X (Chen et al. arXiv:2305.18565).

FIG. 3 is a flow diagram of an example process 300 for generating a target embedding tensor. For convenience, the process 300 will be described as being performed by a system of one or more computers located in one or more locations. For example, a training system, e.g., the training system 100 of FIG. 1, appropriately programmed in accordance with this specification, can perform the process 300.

The training system first initializes an auxiliary embedding tensor (Z) and a dual embedding tensor (A) (step 302).

By initializing an auxiliary embedding tensor, this allows the training system to leverage ADMM to generate a target embedding tensor by decomposing the complex, discretely constrained optimization problem of generating human-readable synthetic data that can fine-tune a generative neural network 106 with similar dynamics to that of real data.

Specifically, the objective function of this optimization problem is reformulated as min_{X} f(X)+I_{E}(Z), s.t. X=Z, where f(X) is the gradient matching loss that measures how well the gradients of the continuous embeddings of a primal embedding tensor (X) match the gradients of the real source data, and I_{E}(Z) is an indicator function that equals 0 if the embedding of each synthetic example can be mapped to a sequence of words in the vocabulary and equals too if otherwise. This allows the ADMM to alternate between minimizing f(X) and ensuring that every embedding in the auxiliary embedding tensor Z is constrained to the discrete vocabulary embedding of the generative neural network. The constraint (s.t. X=Z) links the continuous approximation X and the discrete reality Z, requiring that the optimized continuous embeddings eventually must equal the valid discrete tokens.

In some implementations, the auxiliary embedding tensor Z can be initialized to match an initial primal embedding tensor (e.g., Z⁰=X⁰). The initial primal embedding tensor can be initialized, e.g., by randomly sampling a set of embeddings (optionally requiring them to be valid embeddings from the vocabulary) or by randomly sampling and then taking an optimization step on f.

The dual embedding tensor A denotes the set of Lagrange multipliers of an augmented Lagrange of the above constrained optimization. That is, in some implementations, the augmented Lagrange function is

$${ℒ}_{aug} ( X , Z , Λ ) = f ( X ) + {I}_{E} ( Z ) + \frac{ρ}{2} {‖ X - Z - {ρ}^{- 1} Λ ‖}^{2} ,$$

for parameter

$$ρ > 0 , and \frac{ρ}{2} {‖ X - Z - {ρ}^{- 1} Λ ‖}^{2}$$

is the penalty term.

In some implementations, the dual embedding tensor A is initialized as a tensor of zeros or random values with dimensions matching the primal tensor.

The training system generates an output embedding tensor by optimizing the augmented Lagrange function, with respect to the primal, auxiliary, and dual embedding tensors, while subject to a constraint that each embedding matrix in the auxiliary embedding tensor is a sequence of embedding vectors in the vocabulary embedding having a readability score that satisfies a threshold (step 304).

As described above, the augmented Lagrange function includes the objective function and a penalty term that measures a similarity between: (i) a residual embedding tensor including a difference between the primal and auxiliary embedding tensors, and (ii) the dual embedding tensor. This penalty term thus penalizes discrepancy between the continuous optimization (X) and the discrete constraints (Z), mathematically forcing the two to converge toward each other over iterations.

In some implementations, the penalty function includes a squared Euclidian distance between: (i) the residual embedding tensor comprising the difference between the primal and auxiliary embedding tensors, and (ii) the dual embedding tensor.

In some implementations, the squared Euclidian distance is multiplied by a penalty parameter.

For example, in some implementations, the augmented Lagrange function is

$${ℒ}_{aug} ( X , Z , Λ ) = f ( X ) + {I}_{E} ( Z ) + \frac{ρ}{2} {‖ X - Z - {ρ}^{- 1} Λ ‖}^{2} ,$$

for parameter ρ>0, and

$$\frac{ρ}{2} {‖ X - Z - {ρ}^{- 1} Λ ‖}^{2}$$

is the penalty term.

To optimize this augmented Lagrange function using ADMM, for each of a plurality of iterations, the training system receives a primal, auxiliary, and dual embedding tensor for the current iteration, allowing the training system to evaluate the augmented Lagrange function on the primal, auxiliary, and dual embedding tensors for the current iteration.

At each iteration t, the training system optimizes the augmented Lagrange function evaluated on the primal, auxiliary, and dual embedding tensors for the current iteration, with respect to the primal embedding tensor for the current iteration, to generate the primal embedding tensor for the next iteration. This proximal step optimizes the embeddings to match the gradient with respect to the real dataset.

The training system then performs a projection step that maps the embeddings to tokens in the vocabulary of the generative neural network by first generating an input embedding tensor for the current iteration including a summation of the primal embedding tensor for the next iteration and the dual embedding tensor for the current iteration. Each embedding vector of each embedding matrix in the input embedding tensor for the current iteration is then projected to generate a respective embedding vector of a respective embedding matrix in the auxiliary embedding tensor for the next iteration.

In some implementations, for each embedding vector of each embedding matrix in the input embedding tensor for the current iteration, the training system determines a respective top-k subset of the vocabulary embedding, i.e., by performing a search to return the top k most similar vocabulary embeddings to the embedding vector. The training system then identifies in the respective top-k subset, a respective embedding vector of a token having a highest similarity with the embedding vector of the embedding matrix in the input embedding tensor for the current iteration. The training system returns, as the respective embedding vector of the respective embedding matrix in the auxiliary embedding tensor for the next iteration, the respective embedding vector of the token having the highest similarity with the embedding vector of the embedding matrix in the input embedding tensor for the current iteration.

Having determined the primal and auxiliary embedding tensors for the next iteration, the training system can perform a dual update by first determining the residual embedding tensor based on the difference between the primal and auxiliary embedding tensors for the next iteration. The training system can then increment the dual embedding tensor for the current iteration, with the residual embedding tensor for the next iteration, to generate the auxiliary embedding tensor for the next iteration.

Therefore, at each iteration t, the training system leverages ADMM to solve the augmented Lagrange function above using the following update rules:

$$Primal update : {X}^{t + 1} = {arg min}_{X} {ℒ}_{aug} ( X , {Z}^{t} , {Λ}^{t} ) ,$$

$${Z}^{t + 1} = {arg min}_{Z} {ℒ}_{aug} ( {X}^{t + 1} , {Z}^{t} , {Λ}^{t} ) ,$$

$$Dual update : {Λ}^{t + 1} = {Λ}^{t} + ρ ( {X}^{t + 1} - {Z}^{t + 1} ) ,$$

which are respectively the proximal step, projection step, and dual update. ADMM solves the augmented Lagrange function by minimizing primal variables X, Z and maximizing dual variables A at each iteration t.

The primal update step requires solving an unconstrained optimization problem. When ρ is large, the function is strongly convex in X. In practice, stochastic gradient descent algorithms such as Adam can obtain an approximate solution, which is sufficient for the convergence of ADMM.

The projection step can be rewritten as:

$${Z}^{t + 1} = {arg min}_{Z} {ℒ}_{aug} ( {Z}^{t + 1} , {Z}^{t} , {Λ}^{t} ) = {arg min}_{Z} {I}_{E} ( Z ) + {‖ Z - {X}^{t} - {ρ}^{- 1} {Λ}^{t} ‖}^{2} = {P}_{E} ( {X}^{t} + {ρ}^{- 1} {Λ}^{t} ) .$$

That is, for the vocabulary embeddings E, the projection P_{E}(xᵢ) of an embedding vector xᵢ ∈ [symbol] ^{d} into the vocabulary space is the embedding vector zᵢ:=arg min_{e∈E}∥xᵢ−e∥² corresponding to the token in the vocabulary that is closes to xᵢ in Euclidean space.

The primal embedding tensor for the final iteration is returned as the output embedding tensor.

Using the output embedding tensor, the training system can generate the target embedding tensor representing the synthetic target dataset that the generative neural network generates. To do so, the training system projects each embedding vector of each embedding matrix in the output embedding tensor to generate a respective embedding vector of a respective embedding matrix in the target embedding tensor (step 306). However, projecting embeddings to tokens in vocabulary independently does not yield meaningful text.

To enforce readability of the generated target dataset, the training system first determines, for the embedding vector of the embedding matrix in the output embedding tensor, a respective top-k subset of the vocabulary embedding.

In some implementations, to determine the respective top-k subset of the vocabulary embedding for the embedding vector of the embedding matrix in the output embedding tensor, the training system receives a currently projected embedding matrix that includes, for each preceding embedding vector of the embedding matrix in the output embedding tensor, the respective embedding vector of the token having the highest similarity with the preceding embedding vector. The training system then generates a probability distribution over the vocabulary embedding conditioned on the currently projected embedding matrix. In some implementations, training system processes the currently projected embedding matrix, using the generative neural network, to generate the probability distribution over the vocabulary embedding. From the probability distribution over the vocabulary embedding, the training system determines a respective likelihood of each embedding vector in the vocabulary embedding and returns as the top-k subset of the vocabulary embedding, the k embedding vectors in the vocabulary embedding having the highest respective likelihoods.

In the respective top-k subset, the training system identifies a respective embedding vector of a token having a highest similarity with the embedding vector of the embedding matrix in the output embedding tensor. The training system therefore returns, as the respective embedding vector of the respective embedding matrix in the target embedding tensor, the respective embedding vector of the token having the highest similarity with the embedding vector of the embedding matrix in the output embedding tensor.

While the top-k projection enables generating human-readable text, in some cases it can negatively affect the performance. For example, (i) it may change the category of the synthetic example by including words that are most relevant to other categories; (ii) it may significantly increase the gradient matching loss of some synthetic examples; or (iii) it may result in a much higher gradient matching loss for some categories compared to the rest. To address the above issues, in some implementations, the system filters low-quality synthetic examples out of the target data set after performing the above operations. For example, the system can remove examples that do not belong to the correct category by running a simple few-shot evaluation. As another example, for every category, the system can select a set of synthetic examples with the lowest gradient matching loss and then filter out these examples. As another example, the system can ensure similar gradient matching loss for all categories by dropping examples with highest loss in categories with a higher average loss compared to the rest.

In some implementations, the above description can be adapted to make the techniques differentially private. Differential privacy (DP) is a rigorous mathematical framework that ensures no single data point can be identified or inferred from the output of a statistical or machine learning model. To make the described technique (referred to as “GRADMM”), differentially private, the system injects controlled noise a into a corresponding gradient, which can be the gradient of real data computed as described above or a clipped gradient generated by clipping the gradient of the real data computed as described above. Specifically, GRADMM first computes per-sample gradients of the real data and then optionally clips their l2-norm to a threshold of C. These clipped gradients are then averaged, and Gaussian noise, drawn from N(0, σ²), is added to this average. The added noise scale σ is defined as follows:

$$σ = \{ \begin{matrix}\frac{C \sqrt{2 log \text{?}}}{\text{?}} & if 0 < ε \leq 1 ( Dwork et al . , 2014 ) \\ \frac{C ( c + \sqrt{\text{?}} )}{\sqrt{\text{?}}} & if ε > 1 ( Lowy \& Razaviyayn , 2021 )\end{matrix}$$

$$\text{?} \text{indicates text missing or illegible when filed}$$

where

$$c = \sqrt{log ( \frac{2}{\sqrt{\text{?} + 1} - 1} )}$$

$$\text{?} \text{indicates text missing or illegible when filed}$$

and C is a constant value, e.g., set equal to 1 or another appropriate value. Based on the composition theorem, GRADMM achieves (ε, δ)-DP. This new optimization problem and its augmented Lagrangian objective can be denoted as f(X, ε, δ) and L(X, Z, Λ, ε, δ), respectively.

As ε→∞, the privacy constraint is relaxed and f(X, ε, δ)→f(X), yielding the original optimization problem. The new problem retains the same structure and can be solved using the ADMM procedure described before.

An example algorithm for making use of the described techniques, either with differential privacy or without (equivalent to setting ε=∞) is shown below.

Algorithm 1 GRADient matching w. ADMM (GRADMM)

| | |
|---|---|
| 1: | Input: Constant ρ > 0, ADMM steps T, proj param k, DP param ε, δ |
| 2: | Step 1: Initialization |
| 3: | Random sample X ∈ Γ |
| 4: | Initialize X⁰ = argmin_{xƒ}(X, ε, δ) |
| 5: | Initialize Z⁰ = X⁰ and Λ⁰ ∈ [symbol] |
| 6: | Step 2: ADMM |
| 7: | for t = 0, 1, ..., T − 1 do |
| 8: | Update X: X^{t+1} = argmin_{X} [symbol] (X, Z^{t}, Λ^{t}, ε, δ) |
| 9: | Update Z: Z^{t+1} = [symbol] _{ε}_{ₜₒₚ₋ₖ}(X^{t+1} + ρ⁻¹Λ^{t}) |
| 10: | Update Λ: Λ^{t+1} = Λ^{t} + ρ(X^{t+1} − Z^{t+1}) |
| 11: | end for |
| 12: | [symbol] = [symbol] _{ε}_{ₜₒₚ₋ₖ}(X^{T}) |
| 13: | Step 3: Filtering |
| 14: | Drop samples in [symbol] that do not belong to their category |
| 15: | Select r samples in [symbol] with lowest gradient matching loss |
| 16: | Drop examples with highest loss from categories that have a higher |
| | average gradient matching loss |
| 17: | Output: Remaining synthetic texts in [symbol] . |

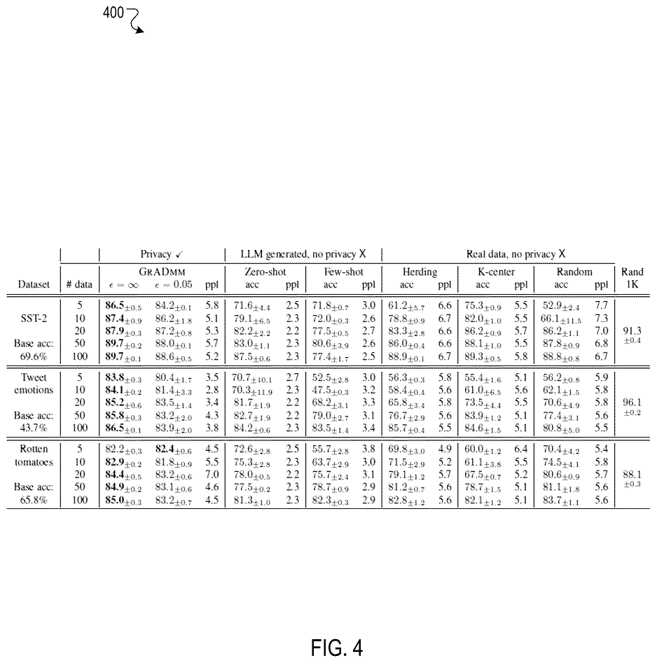

FIG. 4 shows an example 400 of the performance of the described techniques. In particular, FIG. 4 shows the performance in fine-tuning a generative neural network on synthetic examples generated by the described techniques (GRADMM), vs LLM-generated zero-shot and few-shot synthetic data, vs real examples selected with herding, K-center, and Random baselines. As can be seen from FIG. 4, synthetic data generated by GRADMM outperforms the baselines by up to 10.4% and is the only method that can preserve the privacy of the training data. GRADMM's synthetic data has similar log-perplexity (ppl) to that of real data, and higher ppl than LLM-generated synthetic data, confirming its more diverse nature.

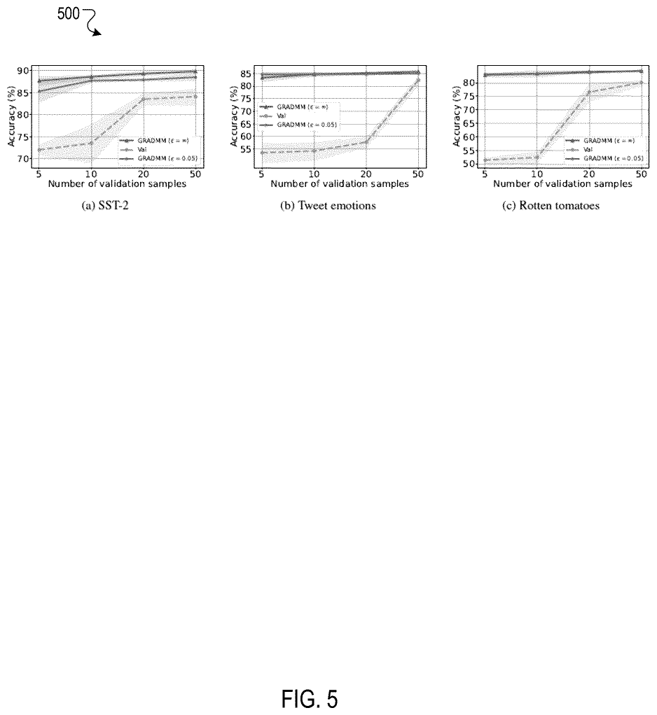

FIG. 5 shows another example 500 of the performance of the described techniques. In particular, FIG. 5 shows the performance of the described techniques in the data scarce regime where relatively few examples are available. More specifically, FIG. 5 shows the effects of generating 100 synthetic samples with GRADMM, based on 5, 10, 20, 50 examples from a target task for three different data sets. The synthetic data generally significantly outperforms the real data. For example, synthetic data generated based on only 5 real examples outperforms the real data by 15.7%, 29.7%, and 31.5% on the three datasets.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers and for fine-tuning a generative neural network, the method comprising:
receiving a source dataset for a downstream task to be performed by the generative neural network, each sample in the source dataset being a sequence of tokens in a vocabulary of the generative neural network;
generating a target dataset for the downstream task by optimizing a performance metric that measures a performance of the generative neural network on the source dataset after being trained on the target data set while constraining each sample in the target dataset to be a respective sequence of tokens in the vocabulary having a readability score that satisfies a threshold; and
training the generative neural network on the target dataset for the downstream task.

2. The method of claim 1, wherein the readability score is a perplexity score.

3. The method of claim 1, wherein training the generative neural network on the target dataset for the downstream task comprises:
evaluating the generative neural network on the target dataset to determine a target performance metric of the generative neural network on the downstream task; and
optimizing the target performance metric with respect to a set of network parameters of the generative neural network.

4. The method of claim 3, wherein optimizing the target performance metric with respect to the set of network parameters of the generative neural network comprises:
computing, with respect to the set of network parameters of the generative neural network, a gradient of the target performance metric; and
updating, in accordance with the gradient of the target performance metric, a respective value of each network parameter in the set of network parameters of the generative neural network.

5. The method of claim 1, wherein generating the target dataset for the downstream task that satisfies the system of constraints comprises:
evaluating the generative neural network on the source dataset for the downstream task to determine a source performance metric of the generative neural network on the downstream task;
computing, with respect to the set of network parameters of the generative neural network, a gradient of the source performance metric;
evaluating the generative neural network on a primal dataset for the downstream task to determine a primal performance metric of the generative neural network on the downstream task;
computing, with respect to the set of network parameters of the generative neural network, a gradient of the primal performance metric; and
generating the target dataset by optimizing an objective function, with respect to the primal dataset, while subject to a constraint that each sample in the primal dataset is a sequence of tokens in the vocabulary having a readability score that satisfies a threshold,
wherein the objective function measures a similarity between: (i) the gradient of the source performance metric, and (ii) the gradient of the primal performance metric.

6. The method of claim 5, wherein the set of network parameters of the generative neural network are the network parameters of a last neural network layer of the generative neural network.

7. The method of claim 5, wherein the objective function comprises a cosine similarity between: (i) the gradient of the source performance metric, and (ii) the gradient of the primal performance metric.

8. The method of claim 5, wherein evaluating the generative neural network on the source dataset for the downstream task to determine the source performance metric of the generative neural network on the downstream task comprises:
encoding each sample in the source data into a respective embedding matrix representing the sample;
processing the respective embedding matrix of each sample in the source dataset, using the generative neural network, to determine a respective performance term for the respective sample in the source dataset; and
returning, as the source performance metric, a summation comprising the respective performance term for each sample in the source dataset.

9. The method of claim 5, wherein evaluating the generative neural network on the primal dataset for the downstream task to determine the primal performance metric of the generative neural network on the downstream task comprises:
initializing a primal embedding tensor comprising, for each sample in the primal dataset, a respective embedding matrix representing the sample;
processing each embedding matrix in the primal embedding tensor, using the generative neural network, to determine a respective performance term for the respective sample in the primal dataset; and
returning, as the primal performance metric, a summation comprising the respective performance term for each sample in the primal dataset.

10. The method of claim 9, wherein for each sample in the source and primal datasets, the respective performance term of the sample is a respective cross-entropy loss of the sample.

11. The method of claim 9, wherein generating the target dataset by optimizing the objective function, with respect to the primal dataset, while subject to the constraint that each sample in the primal dataset is a sequence of tokens in the vocabulary having a readability score that satisfies a threshold comprises:
maintaining a vocabulary embedding comprising, for each token in the vocabulary, a respective embedding vector representing the token;
generating a target embedding tensor by optimizing the objective function, with respect to the primal embedding tensor, while subject to a constraint that each embedding matrix in the primal embedding tensor is a sequence of embedding vectors in the vocabulary embedding having a readability score that satisfies a threshold; and
decoding each embedding matrix in the target embedding tensor into a respective sample in the target dataset.

12. The method of claim 11, wherein generating the target embedding tensor by optimizing the objective function, with respect to the primal embedding tensor, while subject to the constraint that each embedding matrix in the primal embedding tensor is a sequence of embedding vectors in the vocabulary embedding having a readability score that satisfies a threshold comprises:
initializing an auxiliary embedding tensor and a dual embedding tensor;
generating an output embedding tensor by optimizing an augmented Lagrange function, with respect to the primal, auxiliary, and dual embedding tensors, while subject to a constraint that each embedding matrix in the auxiliary embedding tensor is a sequence of embedding vectors in the vocabulary embedding having a readability score that satisfies a threshold,
wherein the augmented Lagrange function comprises the objective function and a penalty function that measures a similarity between: (i) a residual embedding tensor comprising a difference between the primal and auxiliary embedding tensors, and (ii) the dual embedding tensor; and
projecting each embedding vector of each embedding matrix in the output embedding tensor to generate a respective embedding vector of a respective embedding matrix in the target embedding tensor, comprising:
determining, for the embedding vector of the embedding matrix in the output embedding tensor, a respective top-k subset of the vocabulary embedding;
identifying, in the respective top-k subset, a respective embedding vector of a token having a highest similarity with the embedding vector of the embedding matrix in the output embedding tensor; and
returning, as the respective embedding vector of the respective embedding matrix in the target embedding tensor, the respective embedding vector of the token having the highest similarity with the embedding vector of the embedding matrix in the output embedding tensor.

13. The method of claim 12, wherein the penalty function comprises a squared Euclidian distance between: (i) the residual embedding tensor comprising the difference between the primal and auxiliary embedding tensors, and (ii) the dual embedding tensor.

14. The method of claim 13, wherein the squared Euclidian distance is multiplied by a penalty parameter.

15. The method of claim 12, wherein determining, for the embedding vector of the embedding matrix in the output embedding tensor, the respective top-k subset of the vocabulary embedding comprises:
receiving a currently projected embedding matrix comprising, for each preceding embedding vector of the embedding matrix in the output embedding tensor, the respective embedding vector of the token having the highest similarity with the preceding embedding vector;
generating a probability distribution over the vocabulary embedding conditioned on the currently projected embedding matrix;
determining, from the probability distribution over the vocabulary embedding, a respective likelihood of each embedding vector in the vocabulary embedding; and
returning, as the top-k subset of the vocabulary embedding, the k embedding vectors in the vocabulary embedding having the highest respective likelihoods.

16. The method of claim 15, wherein generating the probability distribution over the vocabulary embedding conditioned on the currently projected embedding matrix comprises:
processing the currently projected embedding matrix, using the generative neural network, to generate the probability distribution over the vocabulary embedding.

17. The method of claim 12, wherein generating the output embedding tensor by optimizing the augmented Lagrange function, with respect to the primal, auxiliary, and dual embedding tensors, while subject to the constraint that each embedding matrix in the auxiliary embedding tensor is a sequence of embedding vectors in the vocabulary embedding having a readability score that satisfies a threshold comprises:
for each of a plurality of iterations:
receiving a primal, auxiliary, and dual embedding tensor for the current iteration;
evaluating the augmented Lagrange function on the primal, auxiliary, and dual embedding tensors for the current iteration;
optimizing the augmented Lagrange function evaluated on the primal, auxiliary, and dual embedding tensors for the current iteration, with respect to the primal embedding tensor for the current iteration, to generate the primal embedding tensor for the next iteration;
generating an input embedding tensor for the current iteration comprising a summation of the primal embedding tensor for the next iteration and the dual embedding tensor for the current iteration;
projecting each embedding vector of each embedding matrix in the input embedding tensor for the current iteration to generate a respective embedding vector of a respective embedding matrix in the auxiliary embedding tensor for the next iteration, comprising:
determining, for the embedding vector of the embedding matrix in the input tensor for the current iteration, a respective top-k subset of the vocabulary embedding;
identifying, in the respective top-k subset, a respective embedding vector of a token having a highest similarity with the embedding vector of the embedding matrix in the input embedding tensor for the current iteration; and
returning, as the respective embedding vector of the respective embedding matrix in the auxiliary embedding tensor for the next iteration, the respective embedding vector of the token having the highest similarity with the embedding vector of the embedding matrix in the input embedding tensor for the current iteration; and
incrementing the dual embedding tensor for the current iteration, with the residual embedding tensor for the next iteration, to generate the auxiliary embedding tensor for the next iteration; and
returning, as the output embedding tensor, the primal embedding tensor for the final iteration.

18. The method of claim 1, further comprising evaluating the generative neural network on the source dataset to determine the performance metric that is optimized upon training the generative neural network on the target dataset.

19. The method of claim 1, wherein each sample in the source and target datasets is a sequence of tokens in the vocabulary comprising:
(i) a respective input sequence of tokens in the vocabulary describing a respective implementation of the downstream task; and
(ii) a corresponding output sequence of tokens in the vocabulary describing an expected result of the respective implementation of the downstream task.

20. The method of claim 19, further comprising, upon training the generative neural network on the target dataset for the downstream task:
receiving an input sequence of tokens in the vocabulary describing an implementation of the downstream task; and
processing the input sequence, using the generative neural network, to generate an output sequence of tokens in the vocabulary describing a result of the implementation of the downstream task.

21. The method of claim 1, further comprising:
filtering one or more samples from the target dataset.

22. One or more non-transitory computer storage media storing instructions that, when executed by one or more computers, cause the one or more computers to perform operations for fine-tuning a generative neural network, the operations comprising:
receiving a source dataset for a downstream task to be performed by the generative neural network, each sample in the source dataset being a sequence of tokens in a vocabulary of the generative neural network;
generating a target dataset for the downstream task by optimizing a performance metric that measures a performance of the generative neural network on the source dataset after being trained on the target data set while constraining each sample in the target dataset to be a respective sequence of tokens in the vocabulary having a readability score that satisfies a threshold; and
training the generative neural network on the target dataset for the downstream task.

23. A system comprising:
one or more computers; and
one or more storage devices communicatively coupled to the one or more computers, wherein the one or more storage devices store instructions that, when executed by the one or more computers, cause the one or more computers to perform operations for fine-tuning a generative neural network, the operations comprising:
receiving a source dataset for a downstream task to be performed by the generative neural network, each sample in the source dataset being a sequence of tokens in a vocabulary of the generative neural network;
generating a target dataset for the downstream task by optimizing a performance metric that measures a performance of the generative neural network on the source dataset after being trained on the target data set while constraining each sample in the target dataset to be a respective sequence of tokens in the vocabulary having a readability score that satisfies a threshold; and
training the generative neural network on the target dataset for the downstream task.
